(19) United States
(12) Patent Application Publication
(10) Pub. No.: US 2016/0117695 A1
(43) Pub. Date: Apr. 28, 2016

(54) SYSTEMS AND METHODS FOR REPUTATION MANAGEMENT

(71) Applicant: rocket-fueled, Inc., Decatur, AL (US)

(72) Inventors: David A. Fuller, Decatur, AL (US); Joshua S. Hogue, Harvest, AL (US); Chrispian Burks, Huntsville, AL (US)

(21) Appl. No.: 14/921,767

(22) Filed: Oct. 23, 2015

Related U.S. Application Data
(60) Provisional application No. 62/067,840, filed on Oct. 23, 2014.

(51) Int. Cl. G06Q 30/02

(52) U.S. Cl. CPC G06Q 30/0201

(57) ABSTRACT

A system has a reputation management server that provides a reputation score for each subscriber based on ratings of the subscriber retrieved from one or more transactional servers. The data from the one or more servers is processed to provide an aggregated rating for each subscriber. Another user, such as a buyer or seller in a transaction with the subscriber, can access the reputation management server and be provided with access to the subscriber's rating(s). The reputation management server uses a statistical model to generate statistical data of subscribers based on their retrieved ratings, and the reputation management server assigns a percentile rating to subscribers based on the generated statistical data.

### CROSS-REFERENCE TO RELATED APPLICATIONS

This application claims the benefit of U.S. Provisional Application No. 62/067,840, entitled “Systems and Methods for Reputation Management,” and filed Oct. 23, 2014, which application is hereby incorporated by reference in its entirety.

### RELATED ART

Global commerce continues to grow with providers (e.g., sellers, givers, offerors, contributors or others) and consumers (e.g., buyers, receivers, offerees, beneficiaries or others) exchanging information for completion of online and offline purchases. Both parties of any transaction generally depend on their reputation as a significant component of trust. Trust reduces or eliminates fear and friction in any exchange.

Consumers generally want an assurance that a provider will deliver its goods or services as presented, on the published terms, when promised and may be reluctant to engage with a provider having a low rating. Hence, providers generally strive to build a good reputation in order to attract more consumers.

Conversely, providers generally want consumers who are honest, easy to deal with; and, if payment is involved, pay as promised. They may be understandably wary of consumers with poor reputations. Thus, a consumer generally strives to build a good reputation in order to conduct business transactions and/or to interact in other non-commercial ways with more providers.

Despite the fact that trust is equally important to both provider and consumer, most rating systems emphasize provider ratings over consumer ratings, often to the complete exclusion of consumer ratings.

E-commerce service providers, e.g., eBay, that connect potential providers to consumers, generally provide the potential buyer with ratings of each seller or vice versa. For example, after a seller completes a transaction with a buyer, the buyer may provide feedback rating the seller, and the service provider may calculate a rating indicating the median or average buyer feedback for that seller. These ratings may be expressed in numerous ways, for example 1-5 stars, which might result in a rating of 4.2 stars for a seller. The service provider publishes the seller's rating so that future buyers can use this rating in deciding whether to engage in a transaction with the seller. Generally, buyers might consider completing a transaction only with sellers that have a rating above some chosen value selected by a buyer. A seller's rating or similar ranking is referred to as a seller's reputation. This reputation is based solely on that seller's transactions on a particular service provider, such as eBay, and may or may not be relevant to that seller's activity on any other venue. A seller with an excellent reputation has an advantage over those sellers with a lesser reputation as buyers may be more likely to gravitate to them and/or even pay a premium to do business with a seller they feel is more trustworthy. In order to keep an excellent reputation, it is desirable for a seller to be knowledgeable of his/her/its reputation and use that knowledge to maintain and/or improve its reputation.

There are a variety of reputation managers that maintain reputation ratings of users. In some cases, such as eBay, Internet sellers and service providers have reputation managers embedded in their websites and provide ratings to users of their websites. In other cases, reputation information is gathered and distributed as a service for free or a nominal fee, such as Angie's List, Trip Advisor, Zagat, Chowhound, and others. Long before the online world existed, provider and consumer reputations were being compiled and tracked by Better Business Bureaus and credit rating and reporting agencies.

Further, a reputation manager sometimes collects information from multiple sites and/or other sources and provides aggregated information to a subscriber, free or for a fee, including sellers, buyers, consumer groups, government entities, or interested individuals. The value of aggregated information depends on the multiple factors, such as the sources of data, the attributes of the data, the perceived value of the algorithm used to calculate the ratings, the presentation of results, and other factors.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a reputation management system.

FIG. 2 is a block diagram illustrating an exemplary embodiment of a reputation management server, such as is depicted by FIG. 1.

FIG. 3 depicts exemplary distribution curves of user ratings.

FIG. 4 depicts an exemplary bell-shaped curve of raw user scores.

FIG. 5 is a flow chart illustrating an exemplary method for calculating user percentile ratings.

FIG. 6 depicts exemplary rating scores that may be displayed by a reputation management server, such as is depicted by FIG. 2.

FIG. 7 depicts exemplary rating scores that may be displayed by a reputation management server, such as is depicted by FIG. 2.

FIG. 8 depicts an exemplary graphical user interface (GUI) that may be used to display profile information for a subscriber of a reputation management service provided by a reputation management server, such as depicted by FIG. 2.

### DETAILED DESCRIPTION

The present disclosure generally pertains to systems and methods for providing a reputation management service for online and/or offline usage. In one exemplary embodiment, a system has a reputation management server that provides a reputation score for a subscriber based on ratings of the subscriber retrieved from one or more servers owned or operated by the reputation management service itself and/or by third parties. The data from the one or more servers is processed to provide (an) aggregated rating(s) for the subscriber. Another user, such as a buyer or seller in a transaction with the subscriber, can access the reputation management server and be provided with access to the subscriber's rating(s) and may use such rating(s) in making decisions about whether to engage in online transactions with the subscriber.

In one exemplary embodiment, the reputation management server uses a statistical model to generate statistical data of subscribers based on their retrieved ratings, and the reputation management server assigns a percentile rating to subscribers based on the generated statistical data. The reputation management server further acquires new subscriber ratings and removes stale data from the ratings. In one exemplary embodiment, the reputation management server implements a moving window that removes ratings associated with an age that is older than a certain amount of time, such as 6 months or some other amount of time.

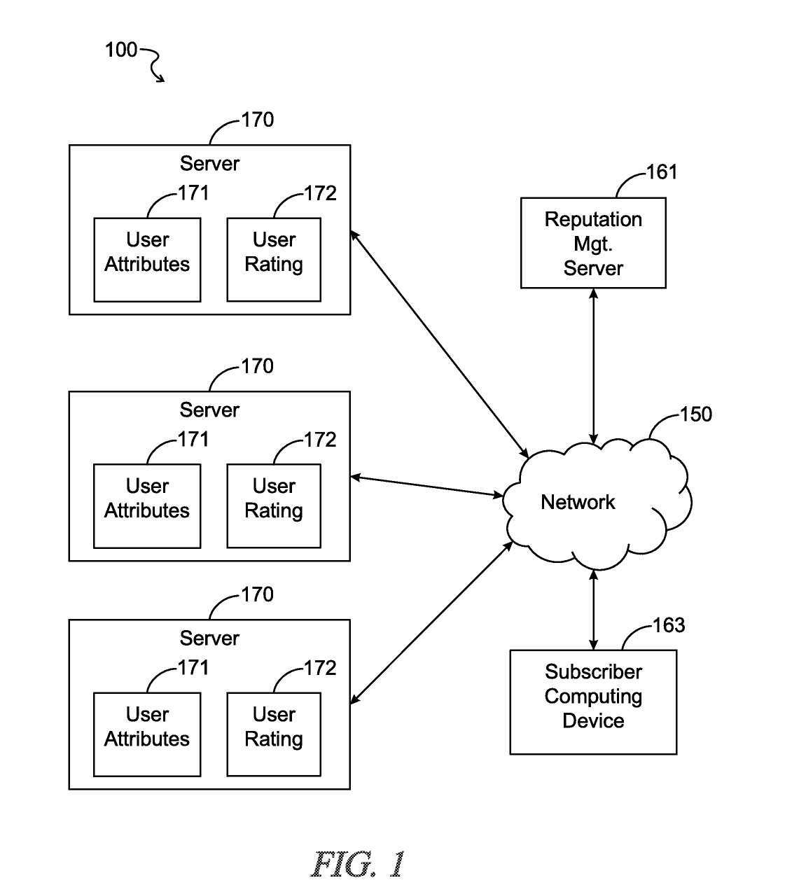

FIG. 1 depicts an exemplary embodiment of a reputation management system 100 of the present disclosure. The reputation management system 100 includes a reputation management server 161 coupled to a network 150. The network 150 is coupled to one or more servers 170, and each of the servers 170 is configured to provide for online and/or offline transactions between users, such as providers and consumers. Servers 170 also send data to reputation management server 161 specific to server 170's system, such as their user reviews/ratings. In one embodiment, the servers 170 can periodically provide data to reputation management server 161, while in other embodiments, the servers 170 can provide data to the reputation management server 161 whenever a user's data has been updated. Reputation management server 161 may return information to one or more of the servers 170. The returned information may include additional reviews or ratings feedback from or about the user, including additional reviews or ratings information from or about a specific counter-party with whom the user may engage in a transaction. The reputation management server 161 can generate and provide the additional information based on the data the reputation management server 161 has received from other servers 170. As an example, each server 170 may store information about its users, including user attributes 171 and user ratings 172 as either providers or consumers. A single user can be either a provider or a consumer depending upon the transaction. User attributes 171 include information that identifies or describes each user, such as the user's identifier, the user's location, the number of transactions completed by the user, comments about the user from counterparties to transactions with the user, and other user information. User ratings 172 as either provider or consumer, also referred to as user rating data, are generally in a form or format established by the owner of the server 170, such as a website, mobile application, offline venue or event. For example, a user may have a percentile rating indicating how positive their feedback rating is in comparison to other users. In addition, comments about the user may be provided along with this feedback rating and/or mined for data to help determine the rating. In general, an unreliable, untrustworthy, or poor-performing user should receive a lower rating than users who are more reliable, trustworthy, or better performing. Categorizing users by percentile has the additional advantage of ranking them against their peers as well as a common metric, such as the aforementioned 1-5 stars. Using percentiles, over and under achievers are immediately apparent. When a rating is less than a certain threshold (e.g., below 40^{th} percentile), the service provider may remove the user from its website, application, venue or event or suspend the user in order to protect counter-parties, its attractiveness to other users and its own reputation, or the service provider may take other actions.

As mentioned above, depending on the scale and rating algorithm used by a service provider, a user may appear to be highly rated but in actuality may be a poor-performing seller relative to other users. For example, it is possible for a user to have a rating over 90% but yet be one of the lowest-rated users on the website. A server 170 of another provider may have another rating scale, such as, from one to five, 1 to 10, 1-5 stars, A to F, or other rating scale. Sometimes ratings suggest an unjustified sense of trust since a rating that is perceived to be high could actually correspond to a user that is rated significantly below his/her/its peers.

In order to ensure that a rating provided by the server 161 is more reliable than current user ratings from a single server 170, the reputation management server 161 retrieves rating data from a plurality of servers 170 and generates statistics in response to the retrieved user ratings. As an example, the server 161 normalizes ratings data for providers and consumers from a plurality of sites to generate a raw rating score for each respective consumer or provider that are all on the same scale, such as from 0 to 100 or some other scale. The server 161 then maps the raw rating scores to percentile ratings where each percentile rating for a given consumer or provider is determined based on the consumer's or provider's raw rating score relative to the raw rating scores of other consumers or providers. That is, the percentile rating for a given consumer or provider is determined by comparing the consumer's or provider's raw rating score to the raw rating scores of other consumers and providers so that the percentile rating is higher when the raw rating score of the given consumer or provider is higher relative to the rating scores of others. As an example, the rating scores may be distributed on a bell-shaped curve such that a consumer or provider with an average rating score is assigned a percentile rating of 50 whereas the consumer or provider with the highest rating score is assigned a percentile rating of 99. Thus, if a consumer or provider has a 90 percentile rating, then that consumer or provider is ranked higher than 90% of the consumers and providers in the population. On the other hand, if a consumer or provider has a percentile rating of 25, then that consumer or provider would be in the lowest quartile. In general, consumers are inclined to patronize providers with a higher percentile rating, such as a provider being in the upper quartile or higher of providers. Providers with high percentile ratings are considered more trustworthy than those with low percentile ratings. The same is true for consumers. Generally, providers seek to attract consumers with higher percentile ratings.

The network 150 depicted in FIG. 1 may include a local area network (LAN), a wide area network (WAN), or any other type of communication network. In one exemplary embodiment, the network can be a WAN with all nodes communicating with the reputation management server 161. The WAN may include numerous devices over different protocols, such as landline computers and/or tablets, smartphones, cellular connected mobile devices, Bluetooth input devices, still and/or video cameras, attachable, wearable, implantable or non-invasive devices as well as other wireless and/or wired input and/or communications devices. In another exemplary embodiment, the network 150 can be the Internet, and messages are communicated across the network 150 using transmission control protocol/Internet protocol (TCP/IP). Other types of networks and other types of protocols are possible in other embodiments.

As shown by FIG. 1, the reputation management system 100 also includes at least one subscriber computing device 163 that is used by a provider or consumer that wishes to communicate with a server 170 or reputation management server 161. Each subscriber computing device 163 is capable of interacting with one of the servers 170 or with the reputation management server 161 or other devices using the network 150 or otherwise. As an example, a subscriber computing device 163 may be implemented as a desktop or laptop computer. A subscriber computing device 163 may also be implemented as a mobile communication device, such as a cellular telephone or smartphone.

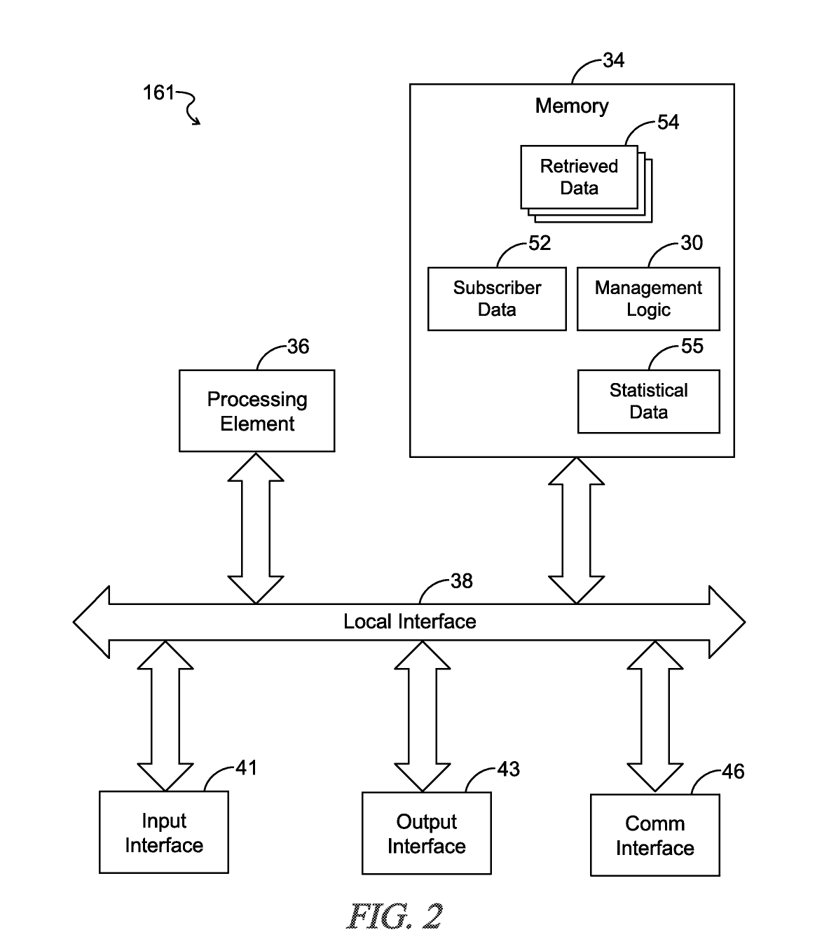

FIG. 2 depicts an exemplary embodiment of the reputation management server 161. As shown by FIG. 2, the reputation management server 161 has management logic 30 for generally controlling the operation of the reputation management server 161, as will be described. The management logic 30 can be implemented in software, hardware, firmware or any combination thereof. In the exemplary reputation management server 161 illustrated by FIG. 2, the management logic 30 is implemented in software and stored in the memory 34 of the reputation management server 161. The memory 34 also stores data retrieved from servers 170, hereafter referred to as “retrieved data 54,” subscriber data 52, and statistical data 55.

Note that the management logic 30, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary management server 161 depicted by FIG. 2 includes at least one conventional processing element 36, such as a digital signal processor (DSP) or a central processing unit (CPU), that is configured to execute instructions from software or firmware stored in memory 34. The processing element 36 communicates to and drives the other elements within the reputation management server 161 via a local interface 38, which can include at least one bus. Furthermore, an input interface 41, for example, a keyboard, keypad or a mouse, can be used to input data from a user of the server 161, and an output interface 43, for example, a printer, monitor, liquid crystal display (LCD), or other display apparatus, can be used to output data to the user. In some cases, the same device, such as a touchscreen, for example, may be configured to input and output data and, thus, used to implement both the input interface 41 and the output interface 43.

Further, the reputation management server 161 also includes a communication interface 46, such as at least one modem, that may be used to communicate data with the network 150 (FIG. 1). Note that the communication interface 46 may be coupled to the network 150 via a physical medium, such as a conductive or optical connection. Alternatively, the communication interface 46 may be configured to communicate with the network 150 wirelessly.

The subscriber data 52 includes information for each user, referred to herein as “subscriber,” registered for receiving service from management information system 100. For each such subscriber, the subscriber data 52 includes a subscriber identifier and contact information, such as address, telephone number, email address, etc. Subscribers may include providers, consumers, consumer groups, government agencies, and others that have chosen to receive information from the reputation management system 100. The subscriber data 52 also includes information that enables the server 161 to retrieve information from the subscriber's account at one or more servers 170. As an example, the subscriber data 52 may indicate an address to be used to contact a server 170 and also indicate credentials, such as a username and password that can be used to access the subscriber's account at the server 170. This information may be used to retrieve the subscriber's rating that is maintained by the server 170, as will be described in more detail hereafter.

In addition, memory 34 also stores statistical data 55 generated by management logic 30 in processing retrieved data 54. In one exemplary embodiment, the statistical data 55 includes normalized Gaussian distributed data, having a bell-shaped distribution, generated by management logic 30 when processing user ratings from servers 170. Further, the statistical data includes percentile ratings calculated for the subscribers.

The reputation management server 161 is configured to retrieve user ratings, user attributes and other information about subscribers from the servers 170. In this regard, the reputation management server 161 connects to the servers 170 via network 150 and uses the subscriber data 52 in order to retrieve user ratings and user attributes about the subscribers. The user ratings from the servers 170 may be on various scales, such as, for example, ratings on a scale of 100, on a scale of 10, on a scale of 0 to 5, on a scale of A to F or other scales. User attributes for a given subscriber may include a name of the subscriber, a location (e.g., address) of the subscriber, dates of user ratings for the subscriber, a category of the subscriber's business, and other information. The retrieved user ratings and user attributes are stored in memory 34.

In accordance with the disclosure, for each subscriber, the reputation management server 161 is configured to generate a raw user score, uᵢ, based on the user ratings, mᵢⱼ, for the subscriber retrieved from servers 170, where “i” is the identity number of the subscriber and “j” is the identity number for a server 170. In one embodiment, a raw user score, uᵢ, is based on the user ratings mᵢⱼ and may also include weighting factors wᵢⱼ associated with the user ratings mᵢⱼ.

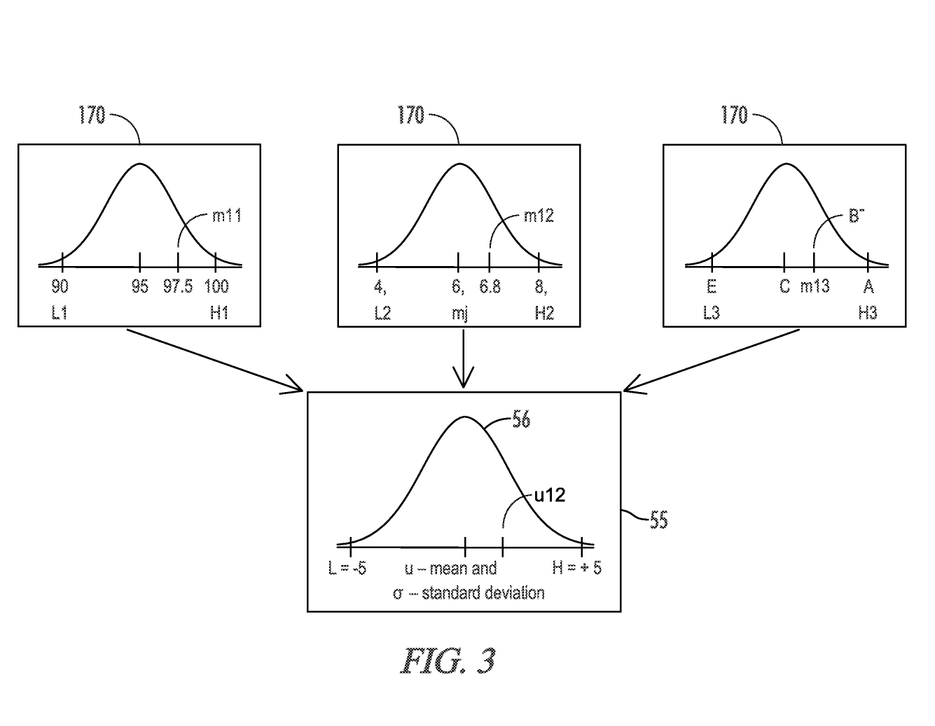

As depicted in FIG. 3, the distribution of a first set of user ratings on a first server 170 has a mean value of around 95, and user ratings may have values between around 90 and 100. The distribution of a second set of user ratings on a second server 170 has a mean value of around 6, and user ratings have values between around 4 and 8. Further, the distribution of a third set of user ratings on a third server 170 has a mean value of C, and user ratings have values between E and A where A is a high user rating.

For each subscriber, there may be a user rating on each server 170 shown as m₁₁, m₁₂, and m₁₃. In order to generate a raw user score, the user ratings from each server 170 are first normalized in order to translate the ratings to a common scale. In one embodiment the common scale for the ratings can be created by the equation, uᵢⱼ=kⱼ*(mᵢⱼ−mⱼ), where kⱼ is a proportionality constant; and mⱼ is the mean value of the scale on the server 170 providing the user rating. In one embodiment, the proportionality constant is determined by the equation kⱼ=(H−L)/(Hⱼ−Lⱼ), where H is the high value for the common scale; L is the low value for the common scale; Hⱼ is the high value for the scale on the server 170 providing the user rating; and Lⱼ is the low value for the scale on the server 170 providing the user rating. For example, consider the second server user rating, m₁₂, of FIG. 3. The user rating, m₁₂, has a value of 6.8, L₂ is 4, and H₂ is 8. The scale for the normalized distribution has L=−5 and H=+5. Inserting the numerical values in the equation for u₁₂, common scale rating for subscriber one of server 2 is 2.0. The values for u₁₁ and u₁₃ can be determined in the same manner. When the user ratings are on a scale from E to A, where A is the highest and B, C, and D represent the other user ratings, numerical values are assigned to the letters as would be done by in a school grading system, wherein A=4, B=3, C=2, D=1, and E=0.

A raw user score uᵢ for each subscriber is a function of the user ratings, uᵢⱼ, and a weighting factor, wᵢⱼ (if any), as described by an equation, uᵢ=f(uᵢⱼ, wᵢⱼ). For example, in one embodiment a user score, u₁=u₁₁*w₁₁+u₁₂*w₁₂+₁₃*w₁₃, where * represents multiplication. Other methods of determining a raw user score are possible in other embodiments. The weighting factors may be assigned as may be desired. For example, a user rating based on feedback from a large number of users may be weighted higher, while a user rating based on feedback from a small number of users may be weighted lower. In one exemplary embodiment, the server 161 is configured to calculate an initial raw user score based on at least one user rating from at least one server 170. Such user rating may be based on feedback from a large number of users of the website hosted by the server 170 from which the rating was retrieved. Further, if ratings are received from multiple servers 170, the ratings may be normalized, possibly weighted, and averaged together or otherwise mathematically combined in order to calculate an initial raw user score.

After defining an initial raw user score, the raw user score may be updated based on feedback from other users or subscribers. For example, after engaging in a transaction with a particular subscriber, a user (who is also a subscriber) may provide a rating to the reputation management server 161 indicating how the subscriber performed in the transaction. In one embodiment, each rating provided by one subscriber on another subscriber can be considered by the reputation management server 161 to be the same as a user rating mᵢⱼ from a server 170. In another embodiment, the ratings provided by one subscriber on another subscriber can be aggregated, either by individual subscribers or groups of subscribers, to form one user rating mᵢⱼ. The rating from the user may also be received by the server 161 from a server 170 or other source during a transmission of data from the server 170 to the reputation management server 161. Based on the new user ratings, the management logic 30 may update the raw user score for the subscriber such that to raw user score changes over time as the subscriber engages in transactions and feedback is received from users involved with the subscriber in the transactions. In any event, for each subscriber of reputation management system 100, there is a raw user score, uᵢ, where i goes from 1 to N. The number, N, is defined as the number of subscribers having a raw user score generated and stored in reputation management server 161.

Reputation management server 161 is further configured to provide a normal distribution for the raw user scores. In one embodiment the mean, u, and the standard deviation, σ, for the normal distribution are determined using the data set comprising user scores, {u₁, u₂, . . . , u_{N}}. The process of generating the normal distribution is based on equations well known to those in the art. The mean, u, may be found by taking the average value of the uᵢ's and the standard deviation may be found by taking the square root of the sum, Σ(uᵢ−u)² for i=1 to N and dividing the square root by N. A representation of the normal distribution of user score values is shown in FIG. 3 as normal distribution curve 56, a bell-shaped curve.

In an embodiment of the present disclosure, reputation management server 161 is configured to add dummy user scores to the data set, {uᵢ}, i=1, 2 . . . N. The dummy user scores are generated and added to raw user scores, uᵢ, when the value of N is small, e.g., less than 10, such as during the initial startup of reputation management system 100. The dummy user scores are predetermined and may be arbitrarily, empirically, or manually generated. Such distributions are converted to the above described common scale. The dummy user scores are the set {u_{dk}), where k=1, 2 . . . M. The combination data set formed by the user scores and the dummy user scores is {uᵢ, u_{dk}} having N+M values. The combination data set has mean, u, and a standard deviation, σ, that are determined using the equations previously described herein. The dummy user scores are fictitious in that they do not relate to any of the actual subscribers of the server 161, and they are provided so that percentile ratings can be generated based on a large number of data points when there are a small number of actual subscribers.

Over an amount of time, as subscribers are added to the reputation management system 100, the number N becomes larger. Thus, the effect of the dummy user scores becomes less and less over time. In one embodiment, the reputation management server 161 is configured to remove a dummy user score for each raw user score added to the combination dataset. Thus, the addition of a raw user score of an actual subscriber essentially replaces a dummy user score so that over time the distribution is more heavily weighted to raw user scores of actual subscribers. Indeed, as dummy user scores are removed, the combination dataset eventually has a population comprising only raw user scores, uᵢ, of actual subscribers. In one embodiment, the selection of a dummy user score to be removed is accomplished by removing the dummy user score nearest to the new raw user score. Thus the transition from dummy to real user data is seamless. Other methods for selecting the dummy user score to remove are possible in other embodiments, such as arbitrarily selecting a dummy user score for removal.

The distribution curve 56 of FIG. 3 approximates a normal distribution curve. If the mean for distribution curve 56 is not equal to zero, then the curve may be shifted by an amount equal to the mean's offset value from zero. Raw user scores would also be shifted by the offset value. Upon generating a normal distribution for raw user scores, a user percentile rating, pi, can be determined for each of the subscribers having a raw user score.

In an effort to keep the raw user score based on current ratings so that the raw user score of a subscriber better reflects the subscriber's recent performance, the reputation management server 161 is configured to remove stale data. For example, the management logic 30 may be configured to compare the age of each user rating, whether from a server 170 or another subscriber, to an age threshold value and to remove each user rating having an age that exceeds the age threshold. Thus, old user ratings are effectively removed and are not used to determine the subscriber's raw user score, uᵢ. Likewise, other configurations of management logic 30 may be used to determine and/or weight the relevance of data.

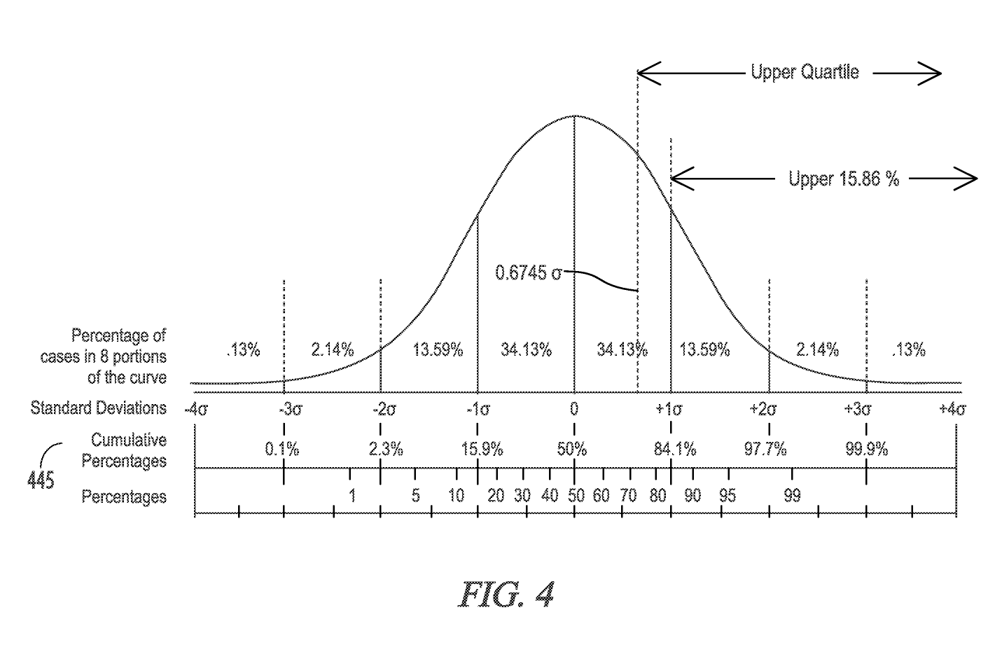

FIG. 4 depicts exemplary relationships between raw user scores and user percentile ratings. The reputation management server 161 is configured to map a raw user score to a user percentile rating. Each raw user score can be expressed as a fractional value of the standard deviation. In that regard, consider a standard deviation of 1.5 and a raw user score of 1.0. Such raw user score is 0.666σ determined by dividing 1.0 by 1.5. When a raw user score is known as a fraction of the standard deviation, the user percentile rating can be found by finding the standard deviation fraction and reading the percentile rating from the cumulative percentages line 445 of FIG. 4. In another embodiment, the data represented by the cumulate percentage line can be stored in a percentile table, where fractional values of the standard deviation are matched with percentile values. In some cases, use of the percentile table involves an interpolation for mapping a raw user score to a user percentile. In other embodiments other mappings of a raw user score to a user percentile rating are possible.

The user percentile ratings maintained by the server 161 are provided to users considering engaging in transactions with the subscribers to which the ratings pertain. As an example, the server 161 may be configured to allow the subscribers to engage in a transaction with users. For a transaction involving a particular subscriber and user, the management logic 30 may be configured to display the subscriber's percentile rating in a webpage that is used for the transaction, such as a sale of a good or service. In another example, one of the servers 170 permits a subscriber to engage in a transaction, and such server 170 is configured to retrieve the subscriber's rating from the server 161 so that the this rating can be reported to another user involved in the transaction. Yet other uses of the ratings maintained by the server 161 are possible in other embodiments.

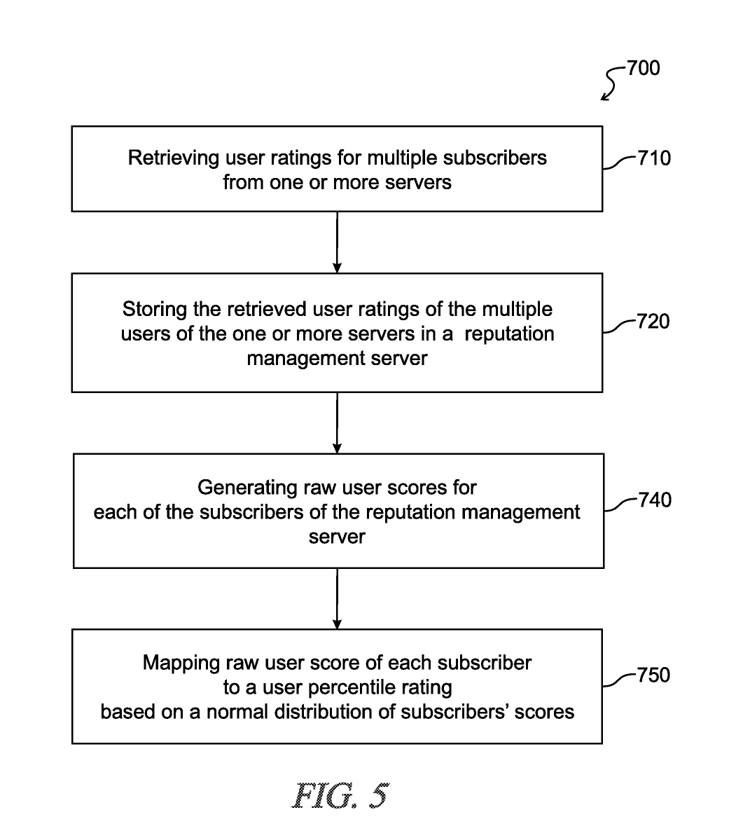

FIG. 5 depicts an exemplary method for generating a percentile rating for a subscriber. The method includes retrieving multiple user ratings from one or more servers 170, step 710. After retrieving the user ratings of multiple subscribers, the method includes storing the retrieved user ratings in a reputation management server 161, step 720. The method further includes generating a raw user score for each subscriber of the reputation management server, step 740. User percentile ratings are then generated based on the raw user scores and a normal statistical distribution of such scores, step 750, so that the percentile rating of each subscriber is indicative of the corresponding raw user score relative to the other raw user scores in the server 161. Exemplary details of the mapping raw user scores to user percentile ratings are provided in the discussion of FIG. 4.

In the embodiments described above, it is assumed that all of the up-to-date scores in the system 100 are used to provide a rating of a given subscriber. In some embodiments, the scores may be categorized so that only a subset of the scores is used to provide a rating of a particular subscriber, as will be described in more detail below. In addition, the user to which the rating is provided is given the option of selecting which category of scores is to be used for the rating.

As an example, as described above, when a subscriber, whether as a provider or consumer, is considering whether to engage in a transaction with another subscriber as a counter-party, the reputation management server 161 is configured to provide the subscriber with a rating of the counter-party so that the subscriber can decide whether to engage the counter-party in the transaction based on the rating. In some cases, it is possible for the subscriber to have previously completed transactions with the counter-party and to have provided feedback for rating the counter-party, and vice versa. In one exemplary embodiment, when a user provides a feedback rating, also referred to herein as a “user rating,” the management logic 30 is configured to correlate the user rating with the identifier of the user who provided the rating. Thus, the management logic 30 is able to determine whether any of the user ratings for a given counter-party were provided by the subscriber to whom the counter-party's rating is now to be reported, thus creating a “personal” score between the two parties. In such case, before providing the counter-party's rating to the subscriber, the management logic 30 is configured to search the user ratings for the counter-party to determine whether any of such ratings were provided by the subscriber. If so, the management logic 30 by default provides a median or average of such user ratings to the subscriber as the counter-party's pre-transaction rating for the potential transaction. In this regard, since the subscriber provided the ratings, the ratings may have more meaning and weight to the subscriber relative to other counter-party ratings from other subscribers. However, if the subscriber prefers a different rating category, the subscriber may provide an input requesting the rating category in which they are interested. Some other exemplary categories will be described in more detail below.

Another rating category shall be referred to hereafter as the “topical” category. In the topical category, a certain set of users (subscribers) correlated with the counter-party is identified. Generally, these users are ones whose opinions are valued by the subscriber not necessarily as family, friends, associates or followed users, but as experts because they have comparatively experienced more of the same or similar transactions with the counter-party and/or are experienced in comparatively more transactions which involve the same or related topic(s), item(s) and/or subject matter (hereinafter “topic”). As an example, the subscriber may provide inputs which define users correlated with the counter-party and/or topic for this topical category. Such users may or may not be acquaintances or friends of the subscriber as their primary qualification is experience with the counter-party and/or the topic. In this regard, during registration and/or usage of the reputation management system 100, each subscriber may be identified as being within a certain topical category based on the types of items that that subscriber expects to or does provide or consume. The management logic 30 is configured to identify users (subscribers) that have completed at least a certain number of transactions with the counter-party or peer subscribers in the same topical category as the transaction being contemplated for the subscriber. Such users are deemed to be knowledgeable by experience about the quality of this type of exchange to expect from the counter-party as well as his/her/its peer subscribers, in a similar role, whether as provider or consumer. In other embodiments, other techniques for determining which users have a unique skill set or experience related to the counter-party on the topic at hand or the counter-party's past performance in comparable transactions are possible.

Once the management logic 30 has identified a set of users for the topical category, the management logic 30 is configured to search the user ratings in order to identify the user ratings that are correlated with at least one such topical expert. The management logic 30 then calculates a raw user score for this topical expert, according to the exemplary techniques described above, only using the foregoing ratings. Thus, the percentile rating ultimately calculated for the counter-party is based on user ratings provided by experts identified for the topical category.

Another rating category shall be referred to hereafter as the “communal” category. In the communal category, a certain set of users correlated with the counter-party, but closely, if not more intimately associated with the subscriber, is identified. Generally, these users are ones whose opinions are valued more by the subscriber than other users because he/she/it has a personal relationship with them; and, because, while the subscriber may not have previously dealt with the counter-party, this group of the subscriber's trusted family, friends, associates or users that the subscriber follows has; or, the subscriber has had previous dealings with this particular counter-party and wants to compare his/her/its rating to the median or average of his/her/its community within the reputation manager's universe. Their experience with the counter-party is relevant primarily because the subscriber knows and trusts them, whether or not he/she/it knows and trusts the counter-party. As an example, the subscriber may provide inputs that identify users that the subscriber trusts and that are also correlated with the counter-party. Such users' primary qualification is: 1) their relationship to the subscriber; and, 2) their experience with the counter-party. In another example, the management logic 30 is configured to automatically determine which users to correlate with the subscriber and counter-party for the communal category. As an example, the reputation management server 161 may host a social network in which the subscriber interacts with certain users in a certain way. As an example, the consumer may identify a group of users as “friends” or other user types that are permitted access to posts or other events related to the subscriber or vice versa. The management logic 30 may be configured to correlate such users with the subscriber for the communal class, provided they also have experience with the counter-party. Alternatively, the management logic 30 may monitor users with which the subscriber communicates and correlate each user that communicates with the subscriber above a threshold amount, such as a certain number of messages over a given time frame; and, in turn, correlate this data with these users' prior experience with the counter-party. Note that, rather than hosting a social network, the server 161 may receive similar information from a social network hosted by another server 170. Yet other techniques for determining which users are to be correlated with the subscriber and counter-party for the communal category are possible.

Once the management logic 30 has identified which users are correlated with the subscriber for the communal category, the management logic 30 is configured to search the user ratings in order to identify the user ratings that are correlated with at least one such user within the subscriber's community. The management logic 30 then calculates a raw user score for the counter-party only using the foregoing scores. Thus, the percentile rating ultimately calculated for the counter-party is based on user ratings provided by users correlated with the subscriber for the communal category.

Another rating category shall be referred to hereafter as the “territorial” category. In the territorial category, a certain set of users associated with a particular application, website, portal, location, event or venue is identified. As an example, the subscriber may be considering a transaction with a counter-party on a particular website, and a set of users who have completed transactions with that counter-party on that website may be identified. Generally, these users are ones who have experience with the counter-party in the same venue being contemplated by the subscriber, whether online or offline.

Once the management logic 30 has identified a set of users for the territorial category, the management logic 30 is configured to search the user ratings in order to identify the user ratings that are correlated with at least one such user. The management logic 30 then calculates a percentile rating for the counter-party, according to the exemplary techniques described above, only using the foregoing ratings. Thus, the percentile rating ultimately calculated for the counter-party is based on user ratings provided by users identified for the territorial category.

Another rating category shall be referred to hereafter as the “global” category. In the global category, all of the up-to-date user ratings for the counter-party are used to calculate the counter-party's raw user score and ultimately percentile rating. In other embodiments, other types of categories may be used to define which user ratings are to be used for determining the counter-party rating that is provided to the subscriber.

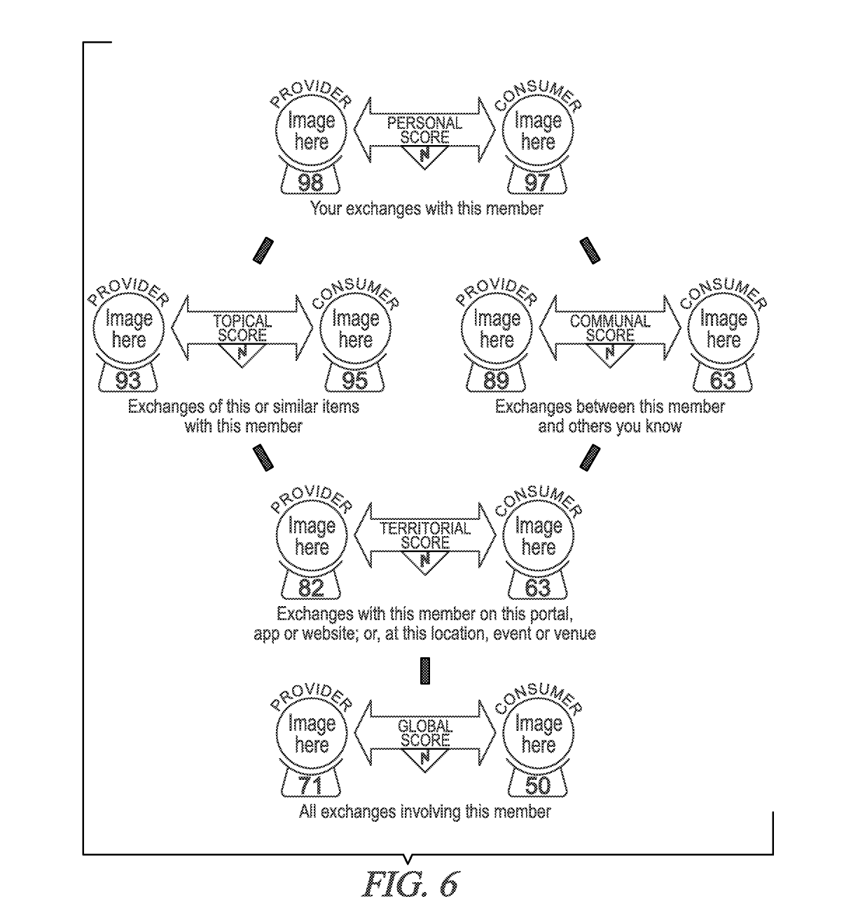

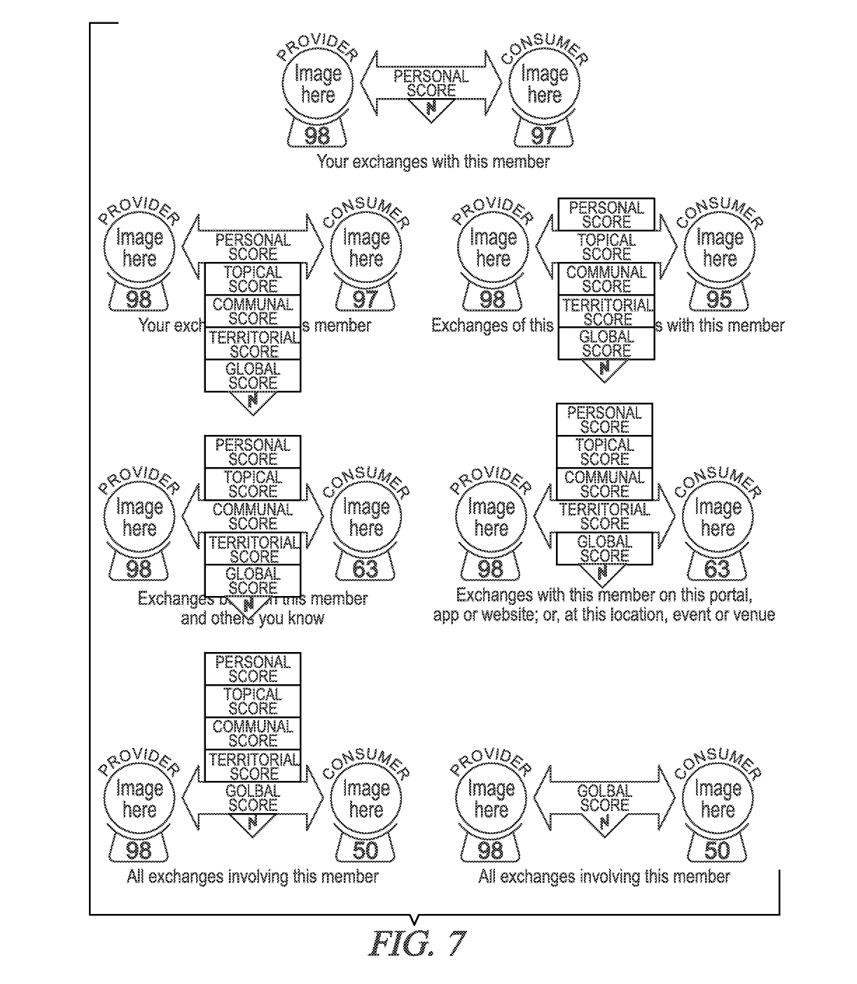

In various embodiments described above, a percentile rating is calculated for a counter-party being contemplated for a transaction. In each case it is also possible to calculate and provide the counter-party's corresponding score for the subscriber and/or the his/her/its median score for the group of users rating them in each category, as shown by FIGS. 6 and 7. In other embodiments other types of ratings may be used. As an example, rather than calculating a percentile rating that is relative to other subscribers, the management logic 30 may be configured to provide the subscriber's raw user score as the rating that is provided by the server 161 for the subscriber. In yet other embodiments, other types of ratings may be used. As an example, by redefining the context, points of reference and/or level of separation between the parties (users) and relabeling the categories in the embodiments described above to rate arms-length transactions, the system described herein may also be applied to other types of transactions and/or interactions, including, but not limited to intra-organizational transactions and/or interactions within a group, company, government agency or other assemblage of parties and/or intra-organizational transactions and/or interactions, as for example, within a supply chain or other assemblage of parties consisting of multiple sub-assemblages of transacting and/or interacting parties.

To encourage users to integrate their profiles from other social networks into the reputation management system 100, an additional social score-based attribute may be included beyond a provider or consumer rating. In one possible embodiment, such a social score-based attribute provides an easy indicator (number, score bar, stars, etc.) to show how complete a user's profile is with respect to linking their account from various social networks. In this regard, for a given user the management logic 30 is configured to calculate a score, referred to hereafter as “social score,” indicating the extent to which the user permits the reputation management server 161 to access the user's social network accounts. The social score is calculated such that, in general, the more accounts of social networks from which the user enables the reputation management servers 161 to retrieve user attributes and user ratings 172, the higher is the user's social score. As described above for the user ratings, the user's social score may be compared against social scores of other users. As an example, the management logic 30 may be configured to calculate a percentile social score relative to the social scores of other users using similar techniques described above for calculating the user's percentile rating. It should be stressed that a user's social score is merely one component in calculating that user's provider or consumer reputation ranking. Nonetheless, linking to users' social networks provides key and instantaneous cross-verification of user identity as well as useful metrics in assessing and/or confirming that user's performance the role of provider or consumer.

It should be noted that various categories of user ratings may be used to calculate a score for a given user. As an example, a given consumer may be rated relative only to other consumers, or a given provider may be rated relative only to other providers. Further, the same person may receive multiple ratings for different categories. For example, a subscriber may be assigned a consumer percentile rating as a consumer that is relative to other consumers, and the same subscriber may be assigned a different percentile rating as a provider that is relative to other providers. The reputation management system scores both sides (provider & consumer) of each transaction. Since every subscriber is, depending on the transaction, either the provider or the consumer; and, over time every subscriber fulfills both roles, switching back and forth as appropriate to each transaction (provider in one transaction, consumer in another), the reputation management system provides each subscriber with scores in both roles. Each subscriber only has one (1) score for each transaction to which they are party, depending on whether they act as the provider or as the consumer. For each transaction, a provider and a consumer score are calculated with each score correlating to the subscriber who fulfills that role in the transaction

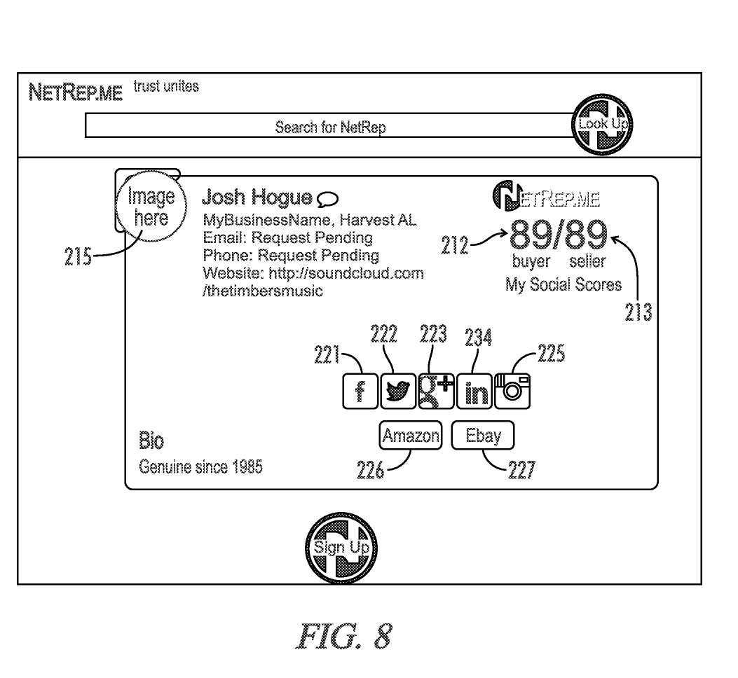

FIG. 8 depicts an exemplary graphical user interface (GUI) that may be displayed by the reputation management logic 30. As an example, such GUI may be transmitted to the subscriber computing device 163 for display on the device 163 so that a user of the device 163 may view the GUI when contemplating a transaction with a subscriber, referred to hereafter as “subscriber of interest,” whose profile information is displayed in the GUI. As shown by FIG. 8, the GUI indicates various personal information about the subscriber of interest, as indicated by the subscriber data 52, such as his name, email address, and an address of a website associated with the subscriber of interest. Such website address may be in the form of a hyperlink that when selected directs the subscriber computing device 163 to the indicated website. The GUI also displays various percentile ratings of the subscriber of interest, such as his buyer (aka consumer) percentile rating 212 (a score rating the subscriber of interest as a buyer relative to other buyers) and seller (aka provider) percentile rating 213 (a score rating the subscriber of interest as a seller relative to other sellers). The GUI also includes an image 215 (e.g., picture, illustration or video) uploaded to the reputation management server 161 by the subscriber of interest. In the exemplary GUI shown by FIG. 8, the image 215 is a picture of the subscriber of interest with his family, but other types of images may be used in other embodiments.

The GUI further includes a plurality of selectable objects 221-227 (e.g., icons with hyperlinks) associated with online sources such as social networks or “shopping” websites. When the user of the device 163 selects an object 221-227, the reputation management logic 30 is configured to use the subscriber data 52 in order to access profile information stored in a social network account or other online account hosted by a remote server 170 and to cause this profile information to be displayed by the subscriber computing device 163. As an example, in response to selection of one of the links 221, the management logic 30 may use the subscriber data 52 (e.g., a temporary, one-use encrypted Facebook token corresponding to the subscriber of interest, such a token permits access to only such Facebook data as the subscriber has granted specific prior consent for a 3^{rd} party, such as the reputation management system 100, to access) in order to access information from the Facebook timeline for the subscriber of interest. The management logic 30 may then cause the device 163 to display such information. In another example, when the object 226 is selected, the profile information for the subscriber of interest stored at an Amazon website may be displayed in a similar manner. Thus, the user of the subscriber computing device 163, by selecting any of the objects 221-227, may be easily directed to profile information for the subscriber of interest maintained by any online source. Viewing profile information maintained by various trusted sites may help the user viewing the GUI to decide whether or not to engage the subscriber of interest in a transaction.

Although the figures herein may show a specific order of method steps, the order of the steps may differ from what is depicted. Also, two or more steps may be performed concurrently or with partial concurrence. Variations in step performance can depend on the software and hardware systems chosen and on designer choice. All such variations are within the scope of the application. Software implementations could be accomplished with standard programming techniques, with rule based logic and other logic to accomplish the various connection steps, processing steps, comparison steps and decision steps.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

What is claimed is:

1. A computer implemented method of rating subscribers to a reputation management service, the method comprising:
receiving, by a first server, one or more ratings from one or more second servers associated with one or more subscribers;
normalizing each rating for a subscriber to a common scale;
generating a raw score for each subscriber based on the normalized ratings for the subscriber; and
calculating a percentile rating for each subscriber relative to the other subscribers based on the generated raw score for each subscriber.

2. The method of claim 1, wherein the step of generating a raw score includes weighting one or more of the normalized ratings for a subscriber.

3. The method of claim 2, wherein the weight applied to one or more of the normalized ratings is based on a number of users submitting feedback on the subscriber to generate the rating on the second server.

4. The method of claim 1, further comprising repeating the steps of normalizing each rating, generating a raw score and calculating a percentile ranking in response to the first server receiving at least one additional rating associated with a subscriber from a second server.

5. The method of claim 1, wherein the step of generating a raw score includes removing ratings having an age exceeding an age threshold.

6. The method of claim 1, wherein the step of calculating a percentile rating includes adding one or more predetermined raw scores to a set of generated raw scores.

7. The method of claim 6, further comprising removing a predetermined raw score from the set of generated raw scores in response to a new generated raw score being added to the set of generated raw scores.

8. The method of claim 1, further comprises:
providing, by a first subscriber, a rating on the first server associated with a second subscriber; and
repeating the steps of generating a raw score and calculating a percentile ranking in response to the provided rating from the first subscriber.

9. The method of claim 8, further comprising:
categorizing the ratings on the first server associated with a second subscriber into a plurality of categories; and
repeating the steps of normalizing each rating, generating a raw score and calculating a percentile ranking for only the ratings in a selected category of the plurality of categories.

10. The method of claim 9, wherein each category of the plurality of categories is based on one or more of a specific context, a specific point of reference or a specific level of separation associated with the user.

11. The method of claim 1, further comprising registering, by each subscriber, with the first server by providing personal information to the first server.

12. The method of claim 11, further comprising transmitting, by the first server, at least a portion of the personal information of the subscriber to the second server to obtain the rating of the subscriber from the second server.

13. A reputation management system comprising:
a first server, the first server configured to receive information related to a plurality of users from at least one second server over a network, the first server comprising logic configured to generate a percentile rating for each user of the plurality of users based on the information received from the at least one second server;
a user device connected to the first server by the network, the user device configured to receive data from a user of the plurality of users and provide the data to the first server to register the user with the first server; and
wherein the information related to the plurality of users includes a rating for each user of the plurality of users, wherein the logic includes computer instructions configured to normalize each user rating to a common scale, generate a raw score for each user based on the normalized ratings and calculate a percentile rating for each user relative to the plurality of users based on the generated raw scores.

14. The system of claim 13, wherein the data provided to the first server by the user includes information to enable the first server to retrieve the information related to the user from the at least one second server.

15. The system of claim 13, wherein the logic includes computer instructions to weight the normalized rating for a user when generating the raw score for the user, wherein the weight applied to the normalized rating is based on a number of users submitting feedback about the user in the information related to the user from the at least one second server.

16. The system of claim 13, wherein the logic is configured to transmit the calculated percentile rating for the user to the at least one second server to aid a counter-party to the user in a transaction on the at least one second server.

17. The system of claim 13, wherein the logic includes computer instructions to remove ratings for a user having an age exceeding an age threshold when generating the raw score for the user.

18. The system of claim 13, wherein the user device is configured to permit one user of the plurality of users to provide a rating on a second user of the plurality of users and wherein the rating from the one user is used by the logic to calculate the percentile ranking of the second user.

19. The system of claim 13, wherein the logic comprises computer instructions to calculate a percentile rating for a user based on a category of ratings associated with the user.

20. The system of claim 19, wherein the category of rating is based on one or more of a specific context, a specific point of reference or a specific level of separation associated with the user.
